(19) United States
(12) Patent Application Publication
(10) Pub. No.: US 2021/0342538 A1
(43) Pub. Date: Nov. 4, 2021

(54) PROCESSING WORD SEGMENTATION AMBIGUITY

(71) Applicant: BEIJING BAIDU NETCOM SCIENCE AND TECHNOLOGY CO., LTD., Beijing (CN)

(72) Inventor: Yanyan LI, Beijing (CN)

(21) Appl. No.: 17/373,635

(22) Filed: Jul. 12, 2021

(30) Foreign Application Priority Data
Dec. 25, 2020 (CN) 202011558317.9

(51) Int. Cl. G06F 40/279; G06F 16/332

(52) U.S. Cl. CPC G06F 40/279; G06F 40/30; G06F 16/3329

(57) ABSTRACT

A word segmentation ambiguity processing method and apparatus, a device, and a medium are provided. The method includes: obtaining a query sentence; performing word segmentation on the query sentence to obtain at least one word segmentation result, each of the at least one word segmentation result including at least one segment; obtaining, for each word segmentation result, a spatial feature corresponding to each of the at least one segment of the word segmentation result; and determining, based on the spatial feature, a target word segmentation result corresponding to the query sentence from the at least one word segmentation result.

### CROSS REFERENCE TO RELATED APPLICATIONS

This application claims priority to Chinese Patent Application No. 202011558317.9, filed on Dec. 25, 2020, the contents of which are hereby incorporated by reference in their entirety for all purposes.

### BACKGROUND

### Technical Field

The present disclosure relates to the technical field of artificial intelligence, in particular to the technical field of natural language processing, and specifically to a word segmentation ambiguity processing method and apparatus, a device, and a medium.

### Description of the Related Art

Word segmentation is the process of recombining a continuous sequence of characters into word sequences according to particular norms. As a basic function in natural language processing, word segmentation is extensively used in various applications of natural language processing. Word segmentation ambiguity processing is one of the biggest challenges to word segmentation systems. Due to the particularity of natural language processing, the requirements vary with different word segmentation scenarios.

### BRIEF SUMMARY

The present disclosure provides a word segmentation ambiguity processing method and apparatus, an electronic device, a computer-readable storage medium, and a computer program product.

According to an aspect of the present disclosure, there is provided a method, comprising: obtaining a query sentence; performing word segmentation on the query sentence to obtain at least one word segmentation result, wherein each of the at least one word segmentation result comprises at least one segment; obtaining, for each word segmentation result of the at least one word segmentation result, a spatial feature corresponding to each segment of the at least one segment of the word segmentation result; and determining, based on the spatial feature, a target word segmentation result corresponding to the query sentence from the at least one word segmentation result.

According to an aspect of the present disclosure, there is provided an electronic device, comprising: at least one processor; and a memory communicatively connected to the at least one processor, wherein the memory stores instructions executable by the at least one processor to cause the at least one processor to perform operations comprising: obtaining a query sentence; performing word segmentation on the query sentence to obtain at least one word segmentation result, wherein each of the at least one word segmentation result comprises at least one segment; obtaining, for each word segmentation result of the at least one word segmentation result, a spatial feature corresponding to each segment of the at least one segment of the word segmentation result; and determining, based on the spatial feature, a target word segmentation result corresponding to the query sentence from the at least one word segmentation result.

According to an aspect of the present disclosure, there is provided a non-transitory computer-readable storage medium storing computer instructions to cause a computer to perform operations comprising: obtaining a query sentence; performing word segmentation on the query sentence to obtain at least one word segmentation result, wherein each of the at least one word segmentation result comprises at least one segment; obtaining, for each word segmentation result of the at least one word segmentation result, a spatial feature corresponding to each segment of the at least one segment of the word segmentation result; and determining, based on the spatial feature, a target word segmentation result corresponding to the query sentence from the at least one word segmentation result.

With the help of one or more example embodiments of the present disclosure, word segmentation is performed on a query sentence to obtain a plurality of word segmentation results; and for each word segmentation result, a spatial feature corresponding to each segment of the word segmentation result is considered, so as to obtain a target word segmentation result based on the spatial feature of the segment. As a result, the accuracy of word segmentation disambiguation is improved.

It should be understood that the content described in this section is not intended to identify critical or significant features of the embodiments of the present disclosure, nor is it intended to limit the scope of the present disclosure. Some features of the present disclosure will be easily comprehensible from the following description.

### BRIEF DESCRIPTION OF THE SEVERAL VIEWS OF THE DRAWINGS

The drawings show embodiments and form a part of the specification, and are used to explain example implementations of the embodiments together with a written description of the specification. The embodiments shown are merely for illustrative purposes and do not limit the scope of the claims. Throughout the drawings, like reference signs denote like but not necessarily identical elements.

FIG. 1 is a schematic diagram of an example system in which various methods described herein can be implemented according to an embodiment of the present disclosure;

FIG. 2 is a flowchart of a word segmentation ambiguity processing method according to an embodiment of the present disclosure;

FIG. 3A is a schematic diagram of the distribution of the segment “Bei Jing Da Xue” (which means Peking University) in an electronic map according to an embodiment of the present disclosure;

FIG. 3B is a schematic diagram of the distribution of the segment “Chang Chun Lu” (which means Changchun Road) in an electronic map according to an embodiment of the present disclosure;

FIG. 4 is a structural block diagram of a word segmentation ambiguity processing apparatus according to an embodiment of the present disclosure; and

FIG. 5 is a structural block diagram of an example electronic device that can be used to implement an embodiment of the present disclosure.

### DETAILED DESCRIPTION

The following describes example embodiments of the present disclosure in conjunction with the accompanying drawings, including various details of the embodiments of the present disclosure to facilitate understanding, and they should be considered as merely example. Therefore, those of ordinary skill in the art should be aware that various changes and modifications can be made to the embodiments described herein, without departing from the scope of the present disclosure. Likewise, for clarity and brevity, descriptions of well-known functions and structures are omitted in the following description.

In the present disclosure, unless otherwise stated, the terms “first,” “second,” etc., used to describe various elements are not intended to limit the positional, temporal or importance relationship of these elements, but rather only to distinguish one component from another. In some examples, the first element and the second element may refer to the same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, it may be one or more, unless otherwise expressly indicated in the context. Moreover, the term “and/or” used in the present disclosure encompasses any of and all possible combinations of listed items.

Word segmentation is the process of recombining a continuous sequence of characters into word sequences according to particular norms. As a basic function in natural language processing, word segmentation is extensively used in various applications of natural language processing. Word segmentation ambiguity processing is one of the biggest challenges to word segmentation systems. Due to the particularity of natural language processing, a word segmentation result often depends on a scenario. In different scenarios, such as a generic search scenario, a map scenario, and an e-commerce scenario, there are different word segmentation disambiguation strategies.

In the related art, word segmentation disambiguation techniques include a word frequency statistics technique, a maximum word priority technique, and a multiple maximum segmentation disambiguation technique. However, the word segmentation disambiguation techniques do not consider a spatial feature of a segment, and the accuracy of word segmentation in a location based service (LBS) scenario is not high. The embodiments of the present disclosure provide a word segmentation ambiguity processing method, in which word segmentation is performed on a query sentence to obtain a plurality of word segmentation results; and for each word segmentation result, a spatial feature corresponding to each segment of the word segmentation result is considered, so as to obtain a target word segmentation result based on the spatial feature of the segment. As a result, by considering the spatial feature of the segment, the accuracy of word segmentation disambiguation is improved.

Embodiments of the present disclosure are described in detail herein in conjunction with the drawings.

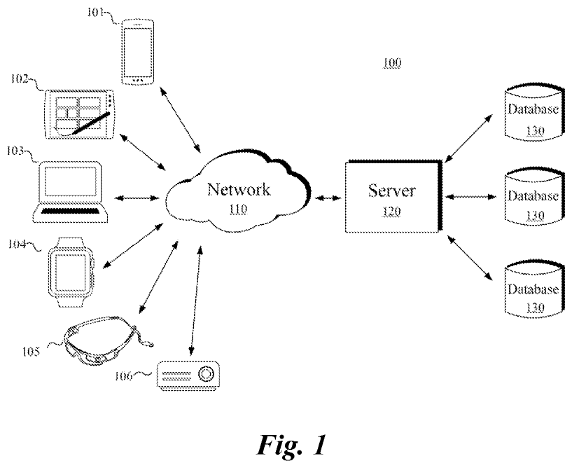

FIG. 1 is a schematic diagram of an example system 100 in which various methods and apparatuses described herein can be implemented according to an embodiment of the present disclosure. Referring to FIG. 1, the system 100 comprises one or more client devices 101, 102, 103, 104, 105, and 106, a server 120, and one or more communication networks 110 that couple the one or more client devices to the server 120.

In some embodiments, the server 120 may further provide some services or software applications that may comprise a non-virtual environment and a virtual environment. In some embodiments, these services may be provided as web-based services or cloud services, for example, provided to a user of the client device 101, 102, 103, 104, 105, and/or 106 in a software as a service (SaaS) model.

In the configuration shown in FIG. 1, the server 120 may comprise one or more components that implement functions performed by the server 120. These components may comprise software components, hardware components, or a combination thereof that can be executed by one or more processors. A user operating the client device 101, 102, 103, 104, 105, and/or 106 may sequentially use one or more client application programs to interact with the server 120, thereby utilizing the services provided by these components. It should be understood that various system configurations are possible, which may be different from the system 100. Therefore, FIG. 1 is an example of the system for implementing various methods described herein, and is not intended to be limiting.

The user can use the client device 101, 102, 103, 104, 105, and/or 106 to enter a query sentence. The client device may provide an interface that enables the user of the client device to interact with the client device. The client device may also output information to the user via the interface. Although FIG. 1 depicts only six types of client devices, those skilled in the art will understand that any number of client devices are possible in the present disclosure.

The client device 101, 102, 103, 104, 105, and/or 106 may include various types of computer devices, such as a portable handheld device, a general-purpose computer (such as a personal computer and a laptop computer), a workstation computer, a wearable device, a gaming system, a thin client, various messaging devices, and a sensor or some sensing devices. These computer devices can run various types and versions of software application programs and operating systems, such as Microsoft Windows, Apple iOS, a UNIX-like operating system, and a Linux or Linux-like operating system (e.g., Google Chrome OS); or include various mobile operating systems, such as Microsoft Windows Mobile OS, iOS, Windows Phone, and Android. The portable handheld device may include a cellular phone, a smart phone, a tablet computer, a personal digital assistant (PDA), etc. The wearable device may include a head-mounted display and some devices. The gaming system may include various handheld gaming devices, Internet-enabled gaming devices, etc. The client device can execute various application programs, such as various Internet-related application programs, communication application programs (e.g., email application programs), and short message service (SMS) application programs, and can use various communication protocols.

The network 110 may be any type of network well known to those skilled in the art, and it may use any one of a plurality of available protocols (including but not limited to TCP/IP, SNA, IPX, etc.) to support data communication. As a mere example, the one or more networks 110 may be a local area network (LAN), an Ethernet-based network, a token ring, a wide area network (WAN), the Internet, a virtual network, a virtual private network (VPN), an intranet, an extranet, a public switched telephone network (PSTN), an infrared network, a wireless network (such as Bluetooth or Wi-Fi), and/or any combination of these and/or other networks.

The server 120 may include one or more general-purpose computers, a dedicated server computer (e.g., a personal computer (PC) server, a UNIX server, or a mid-end server), a blade server, a mainframe computer, a server cluster, or any other suitable arrangement and/or combination. The server 120 may include one or more virtual machines running a virtual operating system, or other levels of virtualization, e.g., an application level virtual machine, or other computing architectures relating to virtualization (e.g., one or more flexible pools of logical storage devices that can be virtualized to maintain virtual storage devices of a server). In various embodiments, the server 120 can run one or more services or software applications that provide functions described herein.

A computing unit in the server 120 can run one or more operating systems including any of the mentioned operating systems and any commercially available server operating system. The server 120 can also run any one of various additional server application programs and/or middle-tier application programs, including an HTTP server, an FTP server, a CGI server, a JAVA server, a database server, etc.

In some implementations, the server 120 may comprise one or more application programs to analyze and merge data feeds and/or event updates received from users of the client devices 101, 102, 103, 104, 105, and 106. The server 120 may further include one or more application programs to display the data feeds and/or real-time events via one or more display devices of the client devices 101, 102, 103, 104, 105, and 106.

In some implementations, the server 120 may be a server in a distributed system, or a server combined with a blockchain. The server 120 may alternatively be a cloud server, or an intelligent cloud computing server or intelligent cloud host with artificial intelligence technologies. The cloud server is a host product in a cloud computing service system, to overcome the shortcomings of difficult management and weak service scalability in conventional physical host and virtual private server (VPS) services.

The system 100 of FIG. 1 may be configured and operated in various manners, such that the various methods and apparatuses described according to the present disclosure can be applied.

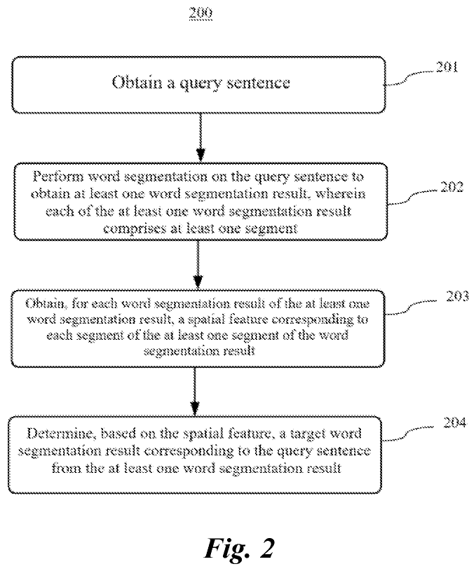

FIG. 2 is a flowchart of a word segmentation ambiguity processing method 200 according to an embodiment of the present disclosure. As shown in FIG. 2, the method according to an example embodiment of the present disclosure comprises: obtaining a query sentence (step 201); performing word segmentation on the query sentence to obtain at least one word segmentation result (step 202), wherein each of the at least one word segmentation result comprises at least one segment; obtaining, for each word segmentation result of the at least one word segmentation result, a spatial feature corresponding to each segment of the at least one segment of the word segmentation result (step 203); and determining, based on the spatial feature, a target word segmentation result corresponding to the query sentence from the at least one word segmentation result (step 204). Since the spatial feature corresponding to the segment is definite, the accuracy of word segmentation disambiguation can be improved by considering the spatial feature of the segment.

Word segmentation is the process of recombining a continuous sequence of characters into word sequences according to particular norms. In the present disclosure, any technique can be used to perform word segmentation on a query sentence to obtain at least one word segmentation result. In some embodiments, any one of a word segmentation technique based on string matching, a word segmentation technique based on statistics, and a word segmentation technique based on understanding can be used for word segmentation. In the word segmentation technique based on string matching, matching is performed between entries in the query sentence and words in a corpus, and then a corresponding word segmentation result is returned. In the word segmentation technique based on statistics, given a large amount of segmented text, a statistical machine learning model is used to learn the rules of word segmentation, thereby implementing segmentation of the query sentence. In the word segmentation technique based on understanding, machines are made to simulate the understanding of the query sentence by humans, to achieve word recognition effects. The word segmentation technique based on understanding performs syntactic and semantic analysis at the same time as word segmentation, and use syntactic and semantic information to deal with ambiguity.

In an embodiment, for the query sentence “Qing Dao Shi Bei Jing Lu Xiao Xue” (which means Beijing Road Elementary School of Qingdao City), a preset word segmentation technique, such as a word segmentation technique based on string matching, a word segmentation technique based on statistics, or a word segmentation technique based on understanding, may be used for word segmentation to obtain at least one word segmentation result, for example, two word segmentation results: Qing Dao Shi/Bei Jing/Lu/Xiao Xue, and Qing Dao Shi/Bei Jing Lu/Xiao Xue. In an embodiment, in the case of performing word segmentation on the query sentence “Bei Jing Da Xue Lao Sheng Wu Lou” (which means Old Building of Biology of Peking University), at least one word segmentation result can also be obtained, for example, four word segmentation results: Bei Jing/Da Xue/Lao Sheng Wu Lou, Bei Jing Da Xue/Lao/Sheng Wu/Lou, Bei Jing Da Xue/Lao/Sheng Wu Lou, and Bei Jing Da Xue/Lao Sheng Wu Lou.

In some embodiments, the spatial feature corresponding to the segment may comprise first spatial information entropy of the segment. The first spatial information entropy of the segment may be information entropy determined based on an area corresponding to the segment in an electronic map. In information theory, entropy is an average amount of information contained in each message (for example, an event, a sample, or a feature) received, and is also referred to as information entropy. Probability distribution of an event and an amount of information of each event constitute a random variable, and the average value e.g., expectation of the random variable is the average value e.g., entropy of an amount of information generated by the probability distribution.

In some embodiments, it is assumed that X is a discrete random variable with n values, wherein n is a positive integer, and its probability distribution is:

P(X=xᵢ)=pᵢ,i=1,2, . . . ,n.

Then entropy of the random variable X may be defined as:

H(X)=−Σᵢ₌₁ⁿpᵢ log pᵢ.

In some examples, probability distribution of a segment may be determined according to an area corresponding to the segment in the electronic map. In some embodiments, the probability distribution of the segment may be expressed as:

P(X=xᵢ)=Area(xᵢ)/Σᵢ₌₁^{k}Area(xᵢ),i=1,2, . . . ,k,

where X denotes the segment, xᵢ is an i^{th} component of the segment X in the electronic map, Area(xᵢ) is an area of xᵢ in the electronic map, and k is a quantity of components of the segment X in the electronic map. In some embodiments, examples of the electronic map may be Baidu Maps, Gaode Maps, Google Maps, etc., which are not limited in the present disclosure. In some embodiments, the area corresponding to the segment in the electronic map may be determined according to point of interest POI data of the segment. The present disclosure does not limit a specific technique for determining an area corresponding to the segment in the electronic map, provided that an area corresponding to the segment in the electronic map can be determined.

In some embodiments, according to the probability distribution of the segment, the first spatial information entropy of the segment may be determined as:

$$H ( X ) = - {\sum }_{i = 1}^{k} [ \frac{Area ( {x}_{i} )}{{\sum }_{i = 1}^{k} Area ( {x}_{i} )} * log ( \frac{Area ( {x}_{i} )}{{\sum }_{i = 1}^{k} Area ( {x}_{i} )} ) ] , \\ i = 1 , 2 , … , k ,$$

where X denotes the segment, xᵢ is an i^{th} component of the segment X in the electronic map, Area(xᵢ) is an area of xᵢ in the electronic map, and k is a quantity of components of the segment X in the electronic map.

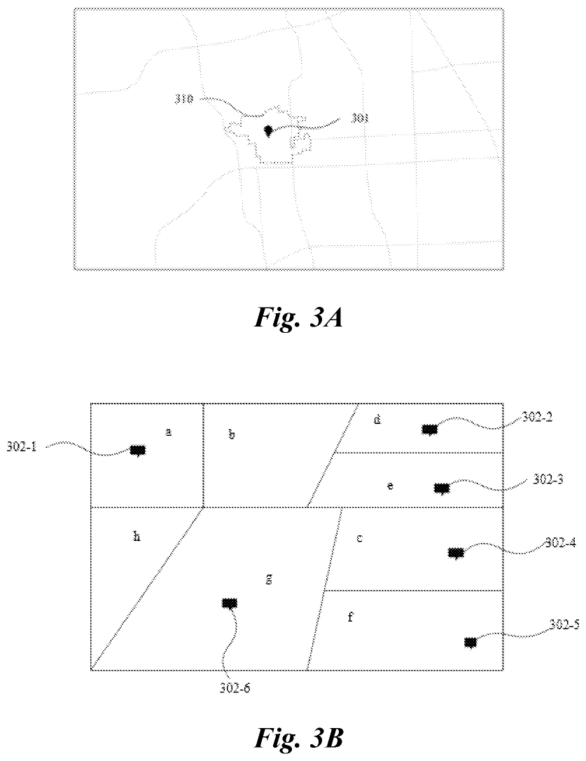

FIG. 3A is a schematic diagram of the distribution of the segment “Bei Jing Da Xue” (which means Peking University) in an electronic map according to an embodiment of the present disclosure. As shown in FIG. 3A, “Bei Jing Da Xue” corresponds to one geographical location 301 in the electronic map, and the geographical location corresponds to an area 310. Then, it can be determined that k=1, and the probability distribution of “Bei Jing Da Xue” is: P(Bei Jing Da Xue==xᵢ), i=1. According to the probability distribution of “Bei Jing Da Xue,” the first spatial information entropy of “Bei Jing Da Xue” may be determined as: H(Bei Jing Da Xue)=0.

FIG. 3B is a schematic diagram of the distribution of the segment “Chang Chun Lu” (which means Changchun Road) in an electronic map according to an embodiment of the present disclosure. As shown in FIG. 3B, “Chang Chun Lu” corresponds to a plurality of geographical locations in the electronic map, for example, six geographical locations 302-1, 302-2, 302-3, 302-4, 302-5, and 302-6. In an embodiment, when it is determined that the probability distribution of “Chang Chun Lu” is (0.1, 0.4, 0.2, 0.2, 0.1), it can be determined that first spatial information entropy of “Chang Chun Lu” is: H(Chang Chun Lu)=2.12.

It can be understood that the segment “Mei Shi” (which means food) also corresponds to a plurality of geographical locations in the electronic map. In an embodiment, when it is determined that the probability distribution of “Mei Shi” is (0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.01, 0.02, 0.03, 0.04, 0.01), it can be determined that the first spatial information entropy of “Mei Shi” is: H(Mei Shi)=6.429.

From the definition of spatial information entropy, it can be known that the larger the entropy corresponding to the segment, the more discrete the distribution of the segment in the electronic map, and the higher the uncertainty of the corresponding point in the electronic map. Therefore, the spatial information entropy can be used to effectively measure the uncertainty of each word segmentation result, to improve the accuracy of word segmentation disambiguation.

In some embodiments, the determining, based on the spatial feature, a target word segmentation result corresponding to the query sentence from the at least one word segmentation result comprises: determining, for each word segmentation result, second spatial information entropy of the word segmentation result according to the first spatial information entropy corresponding to each of the at least one segment of the word segmentation result; and determining, according to the second spatial information entropy of each of the at least one word segmentation result, the target word segmentation result corresponding to the query sentence from the at least one word segmentation result.

In some embodiments, the second spatial information entropy of the word segmentation result may be expressed as a sum of the first spatial information entropy corresponding to each of the at least one segment of the word segmentation result. In some embodiments, for a word segmentation result S of the query sentence, the second spatial information entropy may be expressed as:

H(S)=Σᵢ₌₁ⁿH(X),n=len(split(S)),

where X denotes a segment corresponding to the word segmentation result, split(S) denotes a set of segments of the word segmentation result, and n denotes a quantity of segments in the set.

In some embodiments, the determining, according to the second spatial information entropy of each of the at least one word segmentation result, the target word segmentation result corresponding to the query sentence from the at least one word segmentation result may comprise: determining a word segmentation result with the smallest second spatial information entropy in the at least one word segmentation result as the target word segmentation result. The smaller the information entropy, the more certain the corresponding word segmentation result. Therefore, by determining the word segmentation result with the smallest information entropy as the target word segmentation result, the accuracy of word segmentation disambiguation can be improved.

In an embodiment, for the query sentence S=Qing Dao Shi Bei Jing Lu Xiao Xue, a preset word segmentation method may be used for word segmentation to obtain two word segmentation results, for example, a first word segmentation result S1=Qing Dao Shi/Bei Jing/Lu/Xiao Xue, and a second word segmentation result S2=Qing Dao Shi/Bei Jing Lu/Xiao Xue. Second spatial information entropy of each word segmentation result may be determined according to first spatial information entropy of a corresponding segment in the word segmentation result. For example, second spatial information entropy of the first word segmentation result S1 may be expressed as: H(S1)=H(Qing Dao Shi)+H(Bei Jing)+H(Lu)+H(Xiao Xue). Second spatial information entropy of the second word segmentation result S2 may be expressed as: H(S2)=H(Qing Dao Shi)+H(Bei Jing Lu)+H(Xiao Xue).

First spatial information entropy of each segment may be determined according to the distribution of the segment in the electronic map. In addition, second spatial information entropy of the word segmentation result may be determined, and a word segmentation result with the smallest second spatial information entropy in word segmentation results may be determined as the target word segmentation result of the query sentence. For example, for the query sentence S=Qing Dao Shi Bei Jing Lu Xiao Xue, it can be determined that the second spatial information entropy of the first word segmentation result S1 is 19.86, and the second spatial information entropy of the second word segmentation result S2 is 15.75. Since 15.75 is less than 19.86, the second word segmentation result S2, namely Qing Dao Shi/Bei Jing Lu/Xiao Xue, may be determined as the target word segmentation result of the query sentence S.

In an embodiment, for the query sentence Q=Bei Jing Da Xue Lao Sheng Wu Lou, a preset word segmentation method may be used for word segmentation to obtain four word segmentation results, for example, a first word segmentation result Q1=Bei Jing/Da Xue/Lao Sheng Wu Lou, a second word segmentation result Q2=Bei Jing Da Xue/Lao/Sheng Wu/Lou, a third word segmentation result Q3=Bei Jing Da Xue/Lao/Sheng Wu Lou, and a fourth word segmentation result Q4=Bei Jing Da Xue/Lao Sheng Wu Lou. Second spatial information entropy of each word segmentation result may be determined according to first spatial information entropy of each segment of the word segmentation result, and a word segmentation result with the smallest second spatial information entropy in word segmentation results may be determined as the target word segmentation result of the query sentence. For example, after calculation, it can be determined that the second spatial information entropy corresponding to the fourth word segmentation result Q4 is the smallest, and then the fourth word segmentation result Q4 may be determined as the target word segmentation result of the query sentence Q.

The word segmentation ambiguity processing method according to the example embodiments of the present disclosure has been described herein. Although the various operations are depicted in the drawings in a particular order, this should not be understood as requiring that these operations must be performed in the particular order shown or in a sequential order, nor should it be understood that all operations shown must be performed to obtain the desired result.

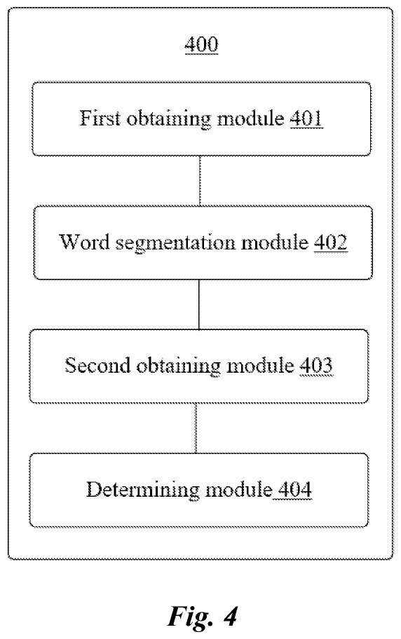

FIG. 4 is a structural block diagram of a word segmentation ambiguity processing apparatus 400 according to an embodiment of the present disclosure. As shown in FIG. 4, the apparatus 400 comprises a first obtaining module 401, a word segmentation module 402, a second obtaining module 403, and a determining module 404.

The first obtaining module 401 is configured to obtain a query sentence.

The word segmentation module 402 is configured to perform word segmentation on the query sentence to obtain at least one word segmentation result. Each of the at least one word segmentation result comprises at least one segment.

The second obtaining module 403 is configured to obtain, for each word segmentation result, a spatial feature corresponding to each of the at least one segment of the word segmentation result.

The determining module 404 is configured to determine, based on the spatial feature, a target word segmentation result corresponding to the query sentence from the at least one word segmentation result.

In some examples, the operations of the first obtaining module 401, the word segmentation module 402, the second obtaining module 403, and the determining module 404 correspond to steps 201 to 204 of the method 200 described herein with respect to FIG. 2, respectively, and therefore details are not be described herein again. Therefore, word segmentation is performed on a query sentence to obtain a plurality of word segmentation results; and for each word segmentation result, a spatial feature of each segment corresponding to the word segmentation result is considered, so as to obtain a target word segmentation result based on the spatial feature of each segment. As a result, the accuracy of word segmentation disambiguation is improved.

Although specific functions are discussed herein with reference to specific modules, it should be noted that the functions of the various modules discussed herein may be divided into a plurality of modules, and/or at least some functions of a plurality of modules may be combined into a single module. The specific module performing actions discussed herein comprises this specific module performing the action itself, or alternatively, this specific module invoking or otherwise accessing a component or module that performs the action (or performs the action together with this specific module). Thus, the specific module performing the action may comprise this specific module performing the action itself and/or a module that this specific module invokes or otherwise accesses to perform the action.

An example embodiment of the present disclosure further provides an electronic device, comprising: at least one processor; and a memory communicatively connected to the at least one processor. The memory stores instructions executable by the at least one processor, and when executed by the at least one processor, the instructions cause the at least one processor to perform the method according to the embodiments of the present disclosure.

An example embodiment of the present disclosure further provides a non-transitory computer-readable storage medium storing computer instructions, wherein the computer instructions are used to cause a computer to perform the method according to the embodiments of the present disclosure.

An example embodiment of the present disclosure further provides a computer program product, comprising a computer program, wherein when the computer program is executed by a processor, the method according to the embodiments of the present disclosure is implemented.

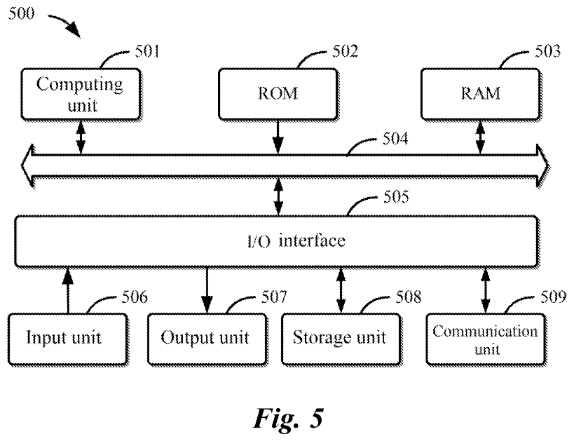

Referring to FIG. 5, a structural block diagram of an electronic device 500 that can serve as a server or a client of the present disclosure is now described, which is an example of a hardware device that can be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown herein, their connections and relationships, and their functions are merely examples, and are not intended to limit the implementation of the present disclosure described and/or required herein.

As shown in FIG. 5, the device 500 comprises a computing unit 501, which may perform various appropriate actions and processing according to a computer program stored in a read-only memory (ROM) 502 or a computer program loaded from a storage unit 508 to a random access memory (RAM) 503. The RAM 503 may further store various programs and data required for the operation of the device 500. The computing unit 501, the ROM 502, and the RAM 503 are connected to each other through a bus 504. An input/output (I/O) interface 505 is also connected to the bus 504.

A plurality of components in the device 500 are connected to the I/O interface 505, including: an input unit 506, an output unit 507, the storage unit 508, and a communication unit 509. The input unit 506 may be any type of device capable of entering information to the device 500. The input unit 506 can receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 507 may be any type of device capable of presenting information, and may include, but is not limited to, a display, a speaker, a video/audio output terminal, a vibrator, and/or a printer. The storage unit 508 may include, but is not limited to, a magnetic disk and an optical disc. The communication unit 509 allows the device 500 to exchange information/data with other devices via a computer network such as the Internet and/or various telecommunications networks, and may include, but is not limited to, a modem, a network interface card, an infrared communication device, a wireless communication transceiver and/or a chip set, e.g., a Bluetooth™ device, a 1302.11 device, a Wi-Fi device, a WiMax device, a cellular communication device and/or the like.

The computing unit 501 may be various general-purpose and/or special-purpose processing components with processing and computing capabilities. Some examples of the computing unit 501 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 501 performs the various methods and processing described herein, for example, the method 200. For example, in some embodiments, the method 200 may be implemented as a computer software program, which is tangibly contained in a machine-readable medium, such as the storage unit 508. In some embodiments, a part or all of the computer program may be loaded and/or installed onto the device 500 via the ROM 502 and/or the communication unit 509. When the computer program is loaded to the RAM 503 and executed by the computing unit 501, one or more steps of the method 200 described herein can be performed. Alternatively, in other embodiments, the computing unit 501 may be configured, by any other suitable means (for example, by means of firmware), to perform the method 200.

Various implementations of the foregoing systems and technologies described herein can be implemented in a digital electronic circuit system, an integrated circuit system, a field programmable gate array (FPGA), an application-specific integrated circuit (ASIC), an application-specific standard product (ASSP), a system-on-chip (SOC) system, a load programmable logic device (CPLD), computer hardware, firmware, software, and/or a combination thereof. These various implementations may comprise: the systems and technologies are implemented in one or more computer programs, wherein the one or more computer programs may be executed and/or interpreted on a programmable system comprising at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program code for implementing the method of the present disclosure can be written in any combination of one or more programming languages. The program code may be provided to a general-purpose computer, a special-purpose computer, or a processor or controller of other programmable data processing devices, such that when the program code is executed by the processor or controller, the functions/operations specified in the flowcharts and/or block diagrams are implemented. The program code may be completely executed on a machine, or partially executed on a machine, or may be, as an independent software package, partially executed on a machine and partially executed on a remote machine, or completely executed on a remote machine or server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable storage medium may include but is not limited to, an electronic, magnetic, optical, electromagnetic, infrared, or semiconductor system, apparatus, or device, or any combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and pointing apparatus (for example, a mouse or a trackball) through which the user can provide an input to the computer. Other types of apparatuses can also be used to provide interaction with the user; for example, feedback provided to the user can be any form of sensory feedback (for example, visual feedback, auditory feedback, or tactile feedback), and an input from the user can be received in any form (including an acoustic input, voice input, or tactile input).

The systems and technologies described herein can be implemented in a computing system (for example, as a data server) comprising a backend component, or a computing system (for example, an application server) comprising a middleware component, or a computing system (for example, a user computer with a graphical user interface or a web browser through which the user can interact with the implementation of the systems and technologies described herein) comprising a frontend component, or a computing system comprising any combination of the backend component, the middleware component, or the frontend component. The components of the system can be connected to each other by means of digital data communication (for example, a communications network) in any form or medium. Examples of the communications network comprise: a local area network (LAN), a wide area network (WAN), and the Internet.

A computer system may comprise a client and a server. The client and the server are generally far away from each other and usually interact through a communications network. A relationship between the client and the server is generated by computer programs running on respective computers and having a client-server relationship with each other.

It should be understood that steps may be reordered, added, or deleted based on the various forms of procedures shown above. For example, the steps recorded in the present disclosure can be performed in parallel, in order, or in a different order, provided that the desired result of the technical solutions disclosed in the present disclosure can be achieved, which is not limited herein.

Although the embodiments or examples of the present disclosure have been described with reference to the drawings, it should be appreciated that the methods, systems and devices described above are merely example embodiments or examples, and the scope of the present disclosure is not limited by the embodiments or examples, but only defined by the appended authorized claims and equivalent scopes thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

The various embodiments described above can be combined to provide further embodiments. Aspects of the embodiments can be modified, if necessary, to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
obtaining a query sentence;
performing word segmentation on the query sentence to obtain at least one word segmentation result, wherein each of the at least one word segmentation result comprises at least one segment;
obtaining, for each word segmentation result of the at least one word segmentation result, a spatial feature corresponding to each segment of the at least one segment of the word segmentation result; and
determining, based on the spatial feature, a target word segmentation result corresponding to the query sentence from the at least one word segmentation result.

2. The method according to claim 1, wherein the spatial feature corresponding to each segment comprises first spatial information entropy of the segment, and
wherein the first spatial information entropy of the segment is information entropy determined based on an area corresponding to the segment in an electronic map.

3. The method according to claim 2, wherein the first spatial information entropy of the segment is determined by using following formula:
$$H ( X ) = - {\sum }_{i = 1}^{k} [ \frac{Area ( {x}_{i} )}{{\sum }_{i = 1}^{k} Area ( {x}_{i} )} * log ( \frac{Area ( {x}_{i} )}{{\sum }_{i = 1}^{k} Area ( {x}_{i} )} ) ] , \\ i = 1 , 2 , … , k ,$$
wherein X is the segment, xᵢ is an i^{th} component of the segment X in the electronic map, Area(xᵢ) is an area of xᵢ in the electronic map, and k is a quantity of components of the segment X in the electronic map.

4. The method according to claim 2, wherein the determining, based on the spatial feature, the target word segmentation result corresponding to the query sentence from the at least one word segmentation result comprises:
determining, for each word segmentation result, second spatial information entropy of the word segmentation result according to the first spatial information entropy corresponding to each of the at least one segment of the word segmentation result; and
determining, according to the second spatial information entropy of each of the at least one word segmentation result, the target word segmentation result corresponding to the query sentence from the at least one word segmentation result.

5. The method according to claim 4, wherein the determining, for each word segmentation result, the second spatial information entropy of the word segmentation result according to the first spatial information entropy corresponding to each of the at least one segment of the word segmentation result comprises:
determining, for each word segmentation result, a sum of the first spatial information entropy corresponding to each of the at least one segment of the word segmentation result as the second spatial information entropy of the word segmentation result.

6. The method according to claim 4, wherein the determining, according to the second spatial information entropy of each of the at least one word segmentation result, the target word segmentation result corresponding to the query sentence from the at least one word segmentation result comprises:
determining a word segmentation result with smallest second spatial information entropy in the at least one word segmentation result as the target word segmentation result.

7. An electronic device, comprising:
at least one processor; and
a memory communicatively connected to the at least one processor,
wherein the memory stores instructions executable by the at least one processor to cause the at least one processor to perform operations comprising:
obtaining a query sentence;
performing word segmentation on the query sentence to obtain at least one word segmentation result, wherein each of the at least one word segmentation result comprises at least one segment;
obtaining, for each word segmentation result of the at least one word segmentation result, a spatial feature corresponding to each segment of the at least one segment of the word segmentation result; and
determining, based on the spatial feature, a target word segmentation result corresponding to the query sentence from the at least one word segmentation result.

8. The electronic device according to claim 7, wherein the spatial feature corresponding to each segment comprises first spatial information entropy of the segment, and
wherein the first spatial information entropy of the segment is information entropy determined based on an area corresponding to the segment in an electronic map.

9. The electronic device according to claim 8, wherein the first spatial information entropy of the segment is determined by using following formula:
$$H ( X ) = - {\sum }_{i = 1}^{k} [ \frac{Area ( {x}_{i} )}{{\sum }_{i = 1}^{k} Area ( {x}_{i} )} * log ( \frac{Area ( {x}_{i} )}{{\sum }_{i = 1}^{k} Area ( {x}_{i} )} ) ] , \\ i = 1 , 2 , … , k ,$$
wherein X is the segment, xᵢ is an i^{th} component of the segment X in the electronic map, Area(xᵢ) is an area of xᵢ in the electronic map, and k is a quantity of components of the segment X in the electronic map.

10. The electronic device according to claim 8, wherein the determining, based on the spatial feature, the target word segmentation result corresponding to the query sentence from the at least one word segmentation result comprises:
determining, for each word segmentation result, second spatial information entropy of the word segmentation result according to the first spatial information entropy corresponding to each of the at least one segment of the word segmentation result; and
determining, according to the second spatial information entropy of each of the at least one word segmentation result, the target word segmentation result corresponding to the query sentence from the at least one word segmentation result.

11. The electronic device according to claim 10, wherein the determining, for each word segmentation result, the second spatial information entropy of the word segmentation result according to the first spatial information entropy corresponding to each of the at least one segment of the word segmentation result comprises:
determining, for each word segmentation result, a sum of the first spatial information entropy corresponding to each of the at least one segment of the word segmentation result as the second spatial information entropy of the word segmentation result.

12. The electronic device according to claim 10, wherein the determining, according to the second spatial information entropy of each of the at least one word segmentation result, the target word segmentation result corresponding to the query sentence from the at least one word segmentation result comprises:
determining a word segmentation result with smallest second spatial information entropy in the at least one word segmentation result as the target word segmentation result.

13. A non-transitory computer-readable storage medium storing computer instructions to cause a computer to perform operations comprising:
obtaining a query sentence;
performing word segmentation on the query sentence to obtain at least one word segmentation result, wherein each of the at least one word segmentation result comprises at least one segment;
obtaining, for each word segmentation result of the at least one word segmentation result, a spatial feature corresponding to each segment of the at least one segment of the word segmentation result; and
determining, based on the spatial feature, a target word segmentation result corresponding to the query sentence from the at least one word segmentation result.

14. The non-transitory computer-readable storage medium according to claim 13, wherein the spatial feature corresponding to each segment comprises first spatial information entropy of the segment, and
wherein the first spatial information entropy of the segment is information entropy determined based on an area corresponding to the segment in an electronic map.

15. The non-transitory computer-readable storage medium according to claim 14, wherein the first spatial information entropy of the segment is determined by using following formula:
$$H ( X ) = - {\sum }_{i = 1}^{k} [ \frac{Area ( {x}_{i} )}{{\sum }_{i = 1}^{k} Area ( {x}_{i} )} * log ( \frac{Area ( {x}_{i} )}{{\sum }_{i = 1}^{k} Area ( {x}_{i} )} ) ] , \\ i = 1 , 2 , … , k ,$$
wherein X is the segment, xᵢ is an i^{th} component of the segment X in the electronic map, Area(xᵢ) is an area of xᵢ in the electronic map, and k is a quantity of components of the segment X in the electronic map.

16. The non-transitory computer-readable storage medium according to claim 14, wherein the determining, based on the spatial feature, the target word segmentation result corresponding to the query sentence from the at least one word segmentation result comprises:
determining, for each word segmentation result, second spatial information entropy of the word segmentation result according to the first spatial information entropy corresponding to each of the at least one segment of the word segmentation result; and
determining, according to the second spatial information entropy of each of the at least one word segmentation result, the target word segmentation result corresponding to the query sentence from the at least one word segmentation result.

17. The non-transitory computer-readable storage medium according to claim 16, wherein the determining, for each word segmentation result, the second spatial information entropy of the word segmentation result according to the first spatial information entropy corresponding to each of the at least one segment of the word segmentation result comprises:
determining, for each word segmentation result, a sum of the first spatial information entropy corresponding to each of the at least one segment of the word segmentation result as the second spatial information entropy of the word segmentation result.

18. The non-transitory computer-readable storage medium according to claim 16, wherein the determining, according to the second spatial information entropy of each of the at least one word segmentation result, the target word segmentation result corresponding to the query sentence from the at least one word segmentation result comprises:
determining a word segmentation result with smallest second spatial information entropy in the at least one word segmentation result as the target word segmentation result.
